(19) United States
(12) Patent Application Publication
(10) Pub. No.: US 2010/0251552 A1
(43) Pub. Date: Oct. 7, 2010

(54) RETRACTABLE RAZOR BLADE RING

(76) Inventors: Casey Gazcon, Turlock, CA (US); Jose Gazcon, Turlock, CA (US)

Correspondence Address: LAW OFFICE OF JERRY D. HAYNES , P.A, P.O. Box 350392, Fort Lauderdale, FL, 33335, US

(21) Appl. No.: 12/420,021

(22) Filed: Apr. 7, 2009

(51) Int. Cl. B26B 3/06; B26B 27/00

(52) U.S. Cl. 30/162; 30/298

(57) ABSTRACT

The present invention relates to a cutting apparatus and the method of using the same, that includes: a blade; a blade holder, which includes a means to conceal the blade; a retraction means, which maintains the blade in a retracted state within the blade holder; a release means, which provides a means to release and protract the blade in a position that makes the blade available for cutting; and a means to attach the blade holder to a finger of a user. The retraction means may include a spring, where the spring at a first end contacts a non-cutting end of the blade. The means to attach may include at least one adjustable strap which firmly wraps about the thumb of a user.

### BACKGROUND OF INVENTION

1. Field of Invention

The present invention relates to a cutting blade apparatus.

2. Description of Related Art

Many cutting devices or apparatuses are available for cutting items such as cardboard or packaging materials that are used in shipping and receiving operations. Many goods are shipped in various types of containers, boxes, plastic enclosures, bags, padded envelopes, sealed envelopes and mailing tubes. Many times goods are also sealed in a plastic bag, shrink wrapped, bubble wrapped and protected in some other manner within the primary shipping box or a container. Upon arrival to the destination, the box and any internal wrapping materials must be removed and opened in order to gain access to the goods.

Utility knives/blades are usually provided to cut open boxes or shipping containers to gain access to the shipped goods. Most utility blades apparatuses involve the use of a handheld blade holder where the utility blade protrudes out of one open end of the holder. The blade retracts into the blade holder after completion of the cutting function. The handheld blade holder is sometimes misplaced during use and therefore one must always be careful in using these devices. Also handheld blade holders occasionally malfunction or are damaged during use. The size of the utility blade can also present a hazard in some instances.

If an individual is working in shipping and receiving or handling a number of boxes it would be advantageous to have a more convenient compact means of cutting packaging material open. Many times the use of a small blade is feasible to open a box due to the fact that one must cut the tape that seals the box in order to open it and in the case of an envelope cutting the seam of the padded envelope.

### SUMMARY OF THE INVENTION

The present invention relates to a cutting apparatus comprising: a blade; a blade holder, where the blade holder includes a means to conceal the blade; a retraction means, where the retraction means maintains the blade in a retracted state within the blade holder; a release means, where said release means provides a means to release and protract the blade in a position which makes the blade available for cutting; and a means to attach the blade holder to a finger of a user. The retraction means includes a spring, where the spring at a first end contacts a non-cutting end of the blade. The release means includes a release button that lies along the outside of the blade holder and contacts the spring at a second end of the spring. The means to attach may include at least one adjustable strap which firmly wraps about the thumb of a user.

### BRIEF DESCRIPTION OF DRAWINGS

FIG. 1A depicts a top view of the blade ring according to the present invention.

FIG. 1B shows a reverse view of the blade ring according to the present invention.

FIG. 1C depicts a side view of the blade ring according to the present invention.

### DETAILED DESCRIPTION

The present invention provides a retractable razor blade ring that is attached to an individual's thumb and provides a means for cutting and opening packaging materials. The retractable blade according to the present invention protrudes from a small blade holder that is part of the blade ring and remains in a retracted position until held open in a protruded position by an individual's index finger. The functionality related to the blade ring according to the present invention is provided by two fingers, index and thumb, once the release is released by the index finger the blade remains retracted in the blade holder.

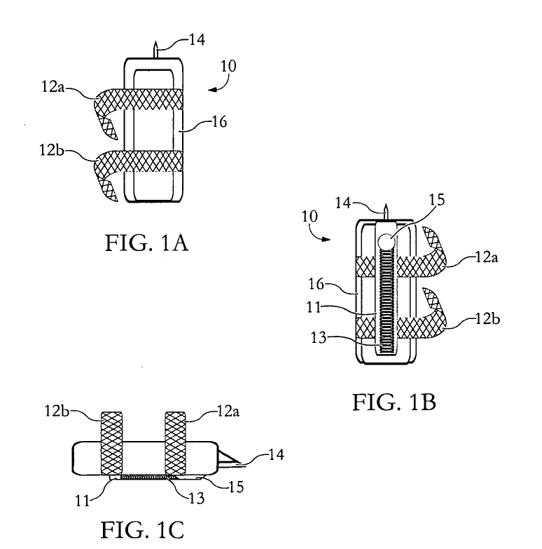

FIG. 1A depicts a blade ring 10 according to the present invention. As depicted in FIG. 1A, blade ring 10 includes a blade 14, blade holder 16, and two straps 12a, 12b. These components comprise the essential makeup of blade ring 10. The blade ring 10 attaches to an individual's thumb by use of the adjustable straps 12a, 12b. When the blade 14 protrudes outside of the blade holder 16 then the blade 14 is ready to use for cutting purposes.

FIG. 1B depicts the other components associated with the blade ring 10. The other components include a release button 15, spring 13 and a spring/blade enclosure 11. The spring 13 maintains the blade 14 in a retracted position when the release button 15 has not been actuated by the index finger. Upon actuation of the release button 15 to a forward position, the blade 14 protrudes from the blade holder 16 and is in the cutting position.

FIG. 1C shows a side view of the blade ring 10 according to the present invention. When placed on an individual's thumb, the release button 15 is therefore positioned on the inside of the individual's thumb therefore making it readily assessable by the individual's index finger. The index finger presses the release button 15 forward to extend the blade 14 into a cutting position. When extended into a cutting position, spring 13 is compressed and therefore upon release of release button 15 the spring expands and therefore retracts the blade into a closed position inside of the blade holder 16.

The blade ring 10 may be utilized on an individual's right or left thumb and is interchangeable between the two. Straps 12a, 12b are adjustable and therefore the blade ring 10 may be adjusted to fit any individual's thumb regardless of width. The blade 14 provides an easily retractable cutting blade that does not require the release and retraction associated with conventional utility cutting blades. Upon release of the release button 15, the blade 14 retracts into a closed position inside the blade holder 16. The blade holder 16 provides a protected opening for the spring/blade enclosure 11 that surrounds the blade 14 when in a closed position and protects the user from exposure when not using the blade 14. Because the blade ring 10 attaches to the thumb the likelihood of being lost or misplaced during use is greatly diminished. Also the blade holder 16 may be covered with a Teflon type of material to avoid penetration and as an added safety feature.

The instant invention has been shown and described in what is considered to be the most practical and preferred embodiments. It is recognized, however, that departures may be made there from within the scope of the invention and that obvious modifications will occur to a person skilled in the art.

What is claimed is:

1. A cutting apparatus comprising
a. a blade;
b. a blade holder, where said blade holder includes a means to conceal the blade;
c. a retraction means, where said retraction means maintains the blade in a retracted state within the blade holder;
d. a release means, where said release means provides a means to release and protract the blade in a position which makes the blade available for cutting; and
e. a means to attach the blade holder to a finger of a user.

2. The cutting apparatus according to claim 1, where the retraction means includes a spring where the spring at a first end contacts a non-cutting end of the blade.

3. The cutting apparatus according to claim 2, where the release means includes a release button that lies along the outside of the blade holder and contacts the spring at a second end of the spring.

4. The cutting apparatus according to claim 1, where the means to attach includes at least one adjustable strap.

5. The cutting apparatus according to claim 4, where the at least one adjustable strap firmly wraps about the thumb of a user.

6. The cutting apparatus according to claim 1, where said blade holder includes an opening that allows the blade to protrude from the blade holder when the blade is in a cutting position.

7. The cutting apparatus according to claim 1, where the blade holder includes a Teflon covering.

8. A method of cutting packaging materials that includes the steps of:
a. placing a blade within a blade holder;
b. maintaining the blade in a retracted position when not in use;
c. providing a means to release blade from the retracted position to a cutting position; and
d. attaching the blade holder to the finger of a user.

9. The method of cutting packaging material according to claim 10, where a spring performs the step of maintaining the blade in a retracted position by expanding within an enclosure within the blade holder.

10. The method of cutting packaging material according to claim 9, further comprising the steps of:
a. providing a release button, where said release button may be actuated by the user;
b. positioning the release button in contact with the spring; and
c. depressing the release button to place the blade in a cutting position.
